(19) United States
(12) Patent Application Publication
(10) Pub. No.: US 2026/0296160 A1
(43) Pub. Date: Oct. 1, 2026

(54) VEHICLE REAR STRUCTURE

(71) Applicant: TOYOTA JIDOSHA KABUSHIKI KAISHA, Toyota-shi (JP)

(72) Inventors: Naoya KAWAMOTO, Nisshin-shi (JP); Nobuyoshi Fujiwara, Nagoya-shi (JP); Kazuya Kumazawa, Nagoya-shi (JP); Kenta Kimura, Nagoya-shi (JP)

(73) Assignee: TOYOTA JIDOSHA KABUSHIKI KAISHA, Toyota-shi (JP)

(21) Appl. No.: 19/468,055

(22) Filed: Feb. 3, 2026

(30) Foreign Application Priority Data
Mar. 26, 2025 (JP) 2025-052166

(51) Int. Cl. B60K 1/04

(52) U.S. Cl. CPC B60K 1/04; B60K 2001/0416

(57) ABSTRACT

A vehicle rear structure includes a battery case that includes an upper case and a lower case, and that accommodates one or more battery modules within, a connector block that is thermally conductive, and that is disposed on a downward side from the upper case in a vehicle up-down direction, and a bus bar that is electrically connected to the battery module, and that is arranged between the upper case and the connector block in the vehicle up-down direction.

### CROSS-REFERENCE TO RELATED APPLICATION

This application claims priority to Japanese Patent Application No. 2025-052166 filed on Mar 26, 2025. The disclosure of the above-identified application, including the specification, drawings, and claims, is incorporated by reference herein in its entirety.

### BACKGROUND

### 1. Technical Field

The disclosure relates to a vehicle rear structure.

### 2. Description of Related Art

Japanese Unexamined Patent Application Publication No. 2023-046977 (JP 2023-046977 A) discloses a battery pack in which a plurality of battery cells having a smoke exhaust port is accommodated in a battery case.

### SUMMARY

When the battery pack described in the above JP 2023-046977 A is installed in a vehicle, various components including bus bars are arranged in a region on a rearward side of the battery case. Bus bars, which are used in batteries and so forth, and are conductors that conduct large amounts of current, tend to generate heat due to conducting current, and there is room for improvement in terms of heat dissipation from bus bars.

The disclosure has been made in view of the above circumstances, and an object thereof is to provide a vehicle rear structure that can dissipate heat generated in bus bars.

A vehicle rear structure according to a first aspect of the disclosure includes a battery case that includes an upper case and a lower case, and that accommodates one or more battery modules within, a connector block that is thermally conductive, and that is disposed on a downward side from the upper case in a vehicle up-down direction, and a bus bar that is electrically connected to the battery module, and that is arranged between the upper case and the connector block in the vehicle up-down direction.

In the vehicle rear structure according to the first aspect of the disclosure, the bus bar is arranged between the connector block that has thermal conductivity and the upper case, in the vehicle up-down direction, and accordingly heat generated in the bus bar can be dissipated through the connector block.

In the vehicle rear structure according to a second aspect of the disclosure, in the configuration of the first aspect, the upper case indirectly abuts against the connector block via the lower case.

In the vehicle rear structure according to the second aspect of the disclosure, the upper case is indirectly connected to the connector block via the lower case, and accordingly heat dissipated from the bus bar toward the upper case can be dissipated via the connector block. This enables the heat generated in the bus bar to be efficiently dissipated via the connector block.

In the vehicle rear structure according to a third aspect of the disclosure, in the configuration of the second aspect, the connector block includes a peripheral edge portion that abuts against the lower case, and indirectly abuts against the upper case via the lower case.

In the vehicle rear structure according to the third aspect of the disclosure, the connector block has the peripheral edge portion thereof abutted against the lower case, and is indirectly abutted against the upper case via the lower case, and accordingly heat dissipated from the bus bar toward the upper case can be dissipated via the connector block. This enables the heat generated in the bus bar to be dissipated even more efficiently via the connector block.

In the vehicle rear structure according to a fourth aspect of the disclosure, in the configurations of any one of the first aspect to the third aspect, the connector block is made of aluminum.

In the vehicle rear structure according to the fourth aspect of the disclosure, the connector block is made of aluminum, and accordingly heat dissipated from the bus bar toward the upper case can be efficiently dissipated via the connector block.

The vehicle rear structure according to the disclosure has excellent advantages of being able to dissipate heat generated in the bus bar.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view illustrating a vehicle rear structure according to an embodiment;

FIG. 2 is a side cross-sectional view illustrating an example of the vehicle rear structure according to the embodiment;

FIG. 3 is an enlarged principal portion perspective view illustrating principal portions of the vehicle rear structure according to the embodiment in an enlarged manner;

FIG. 4 is a schematic cross-sectional view of the vehicle rear structure illustrated in FIG. 1, taken along line A-A; and

FIG. 5 is an exploded perspective view illustrating principal portions of a rear part of a storage battery pack illustrated in FIG. 1, in an enlarged manner.

### DETAILED DESCRIPTION OF EMBODIMENTS

Hereinafter, a vehicle rear structure 14 according to an embodiment of the present disclosure will be described with reference to the drawings. Note that in the following, the scope necessary for describing the technology of the present disclosure will be described primarily, and parts that are omitted from description will be based on known technology. Also, the same or similar signs are used for members that are the same as or corresponding to each other in the drawings, and repetitive description will be omitted. Further, when a number of mutually identical or corresponding members are included in a drawing, only some of them may be denoted with reference numerals, in order to facilitate viewing of the drawing. In the drawings, arrow FR, arrow UP, and arrow LH indicate a vehicle forward direction, a vehicle upward direction, and a vehicle leftward direction of a vehicle 10, respectively. In the following description, unless otherwise specified, terms of directions front-rear, up-down, and right-left are used to refer to front and rear in a vehicle front-rear direction, up and down in a vehicle up-down direction, and right and left in a vehicle width direction (right-left direction), respectively.

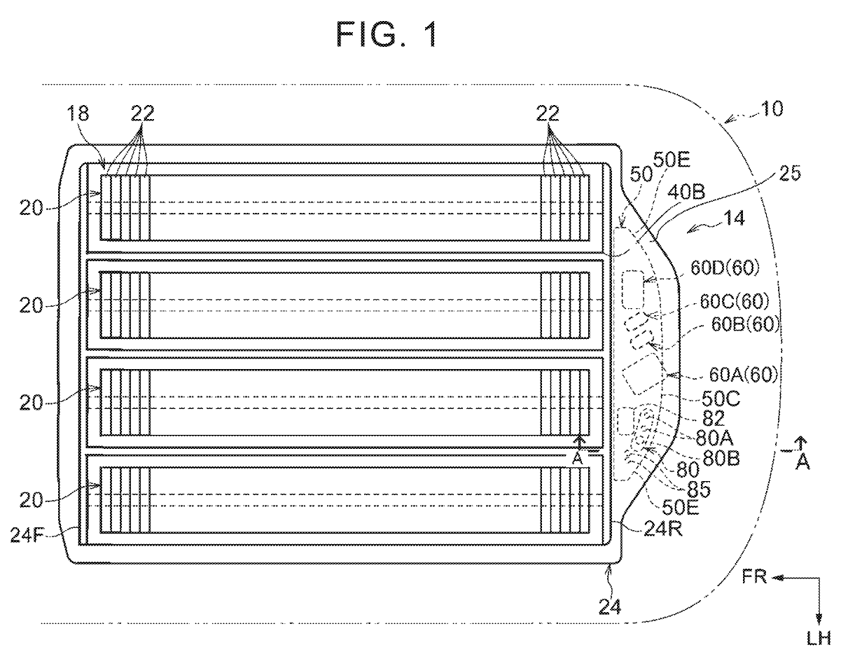

FIG. 1 is a schematic plan view partially illustrating an example of the vehicle 10 equipped with the vehicle rear structure 14 according to the present embodiment. Note that in FIG. 1, an upper case 26, which will be described later, is omitted from illustration.

As illustrated in FIG. 1, a storage battery pack 18 is installed in the vehicle 10. The storage battery pack 18 includes a plurality (four in the present embodiment) of storage battery modules 20. The storage battery modules 20 are disposed arrayed side by side in the vehicle width direction. Each of the storage battery modules 20 has a plurality of storage battery cells 22 as storage battery cells. The storage battery cells 22 are disposed in the storage battery module 20, disposed arrayed side by side in the front-rear direction of the vehicle. That is to say, the storage battery pack 18 is configured such that the storage battery modules 20, each having the storage battery cells 22 disposed arrayed side by side in the vehicle front-rear direction, are disposed arrayed side by side in the vehicle width direction.

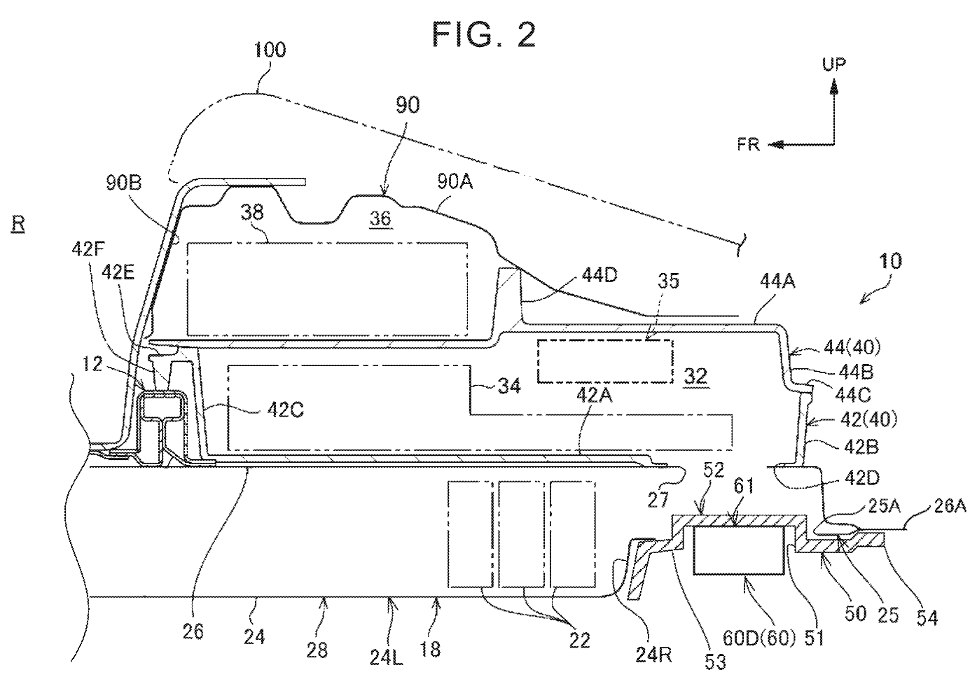

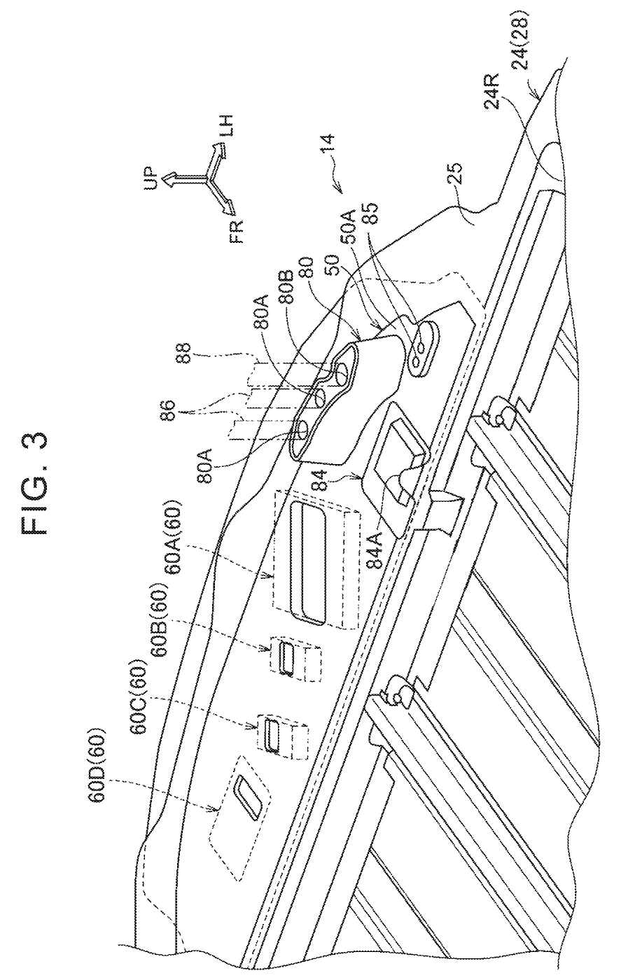

FIG. 2 is a side cross-sectional view illustrating an example of the vehicle rear structure according to the present embodiment. As illustrated in FIG. 2, the storage battery pack 18 has a lower case 24 and the upper case 26. The lower case 24 is a box-shaped member capable of accommodating the storage battery modules 20, and is configured including a lower plate 24L, a front plate 24F (see FIG. 1), a rear plate 24R, and a pair of right and left side plates (omitted from illustration). Also, an upper face of the lower case 24 is open, and as illustrated in FIG. 1, the lower case 24 has a flange portion 25 (see FIG. 3) that extends outward from a periphery thereof.

The upper case 26 is a lid-like member that covers the upper face of the lower case 24. As illustrated in FIG. 2, an opening portion 27 is formed at a rear-end portion of the upper case 26. Through this opening portion 27, an equipment disposal space 32 of an equipment case 40, which will be described later, communicates with an interior of the storage battery pack 18.

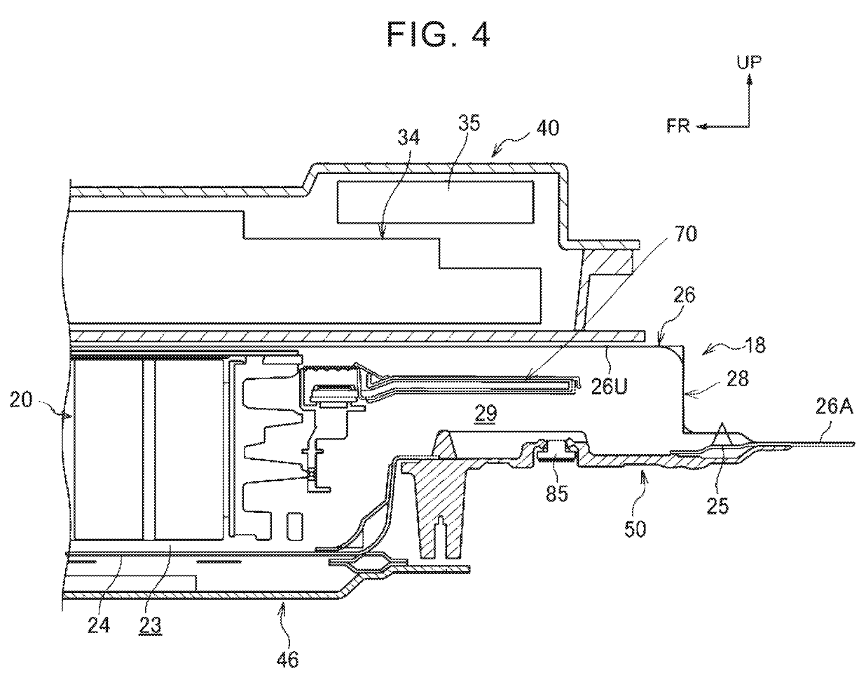

The periphery of the lower case 24 and the periphery of the upper case 26 are joined together, and the lower case 24 and the upper case 26 together make up a storage battery case 28 serving as a battery case. The storage battery modules 20, made up of multiple storage battery cells 22, are accommodated in internal space of this storage battery case 28 and are disposed arrayed side by side in the vehicle width direction. Note that a shear panel 46 (see FIG. 4) extending in the vehicle front-rear direction and also in the vehicle width direction is provided downward from the storage battery pack 18.

As illustrated in FIG. 2, the equipment case 40 that accommodates various types of equipment is disposed on a cabin R side on an upward side of the storage battery case 28. The equipment case 40 includes an equipment base 42 and a lid 44. The equipment base 42 is a box-shaped housing that is open at the vehicle upward side, i.e., at the top end thereof, and is disposed on an upper face of the upper case 26 of the storage battery case 28. The equipment base 42 includes a lower wall portion 42A, a rear wall portion 42B, and a front wall portion 42C. An opening 42D is formed in a rearward portion of the lower wall portion 42A, through which a harness or the like, omitted from illustration, passes. The equipment base 42 also includes a front-side flange portion 42E and a boss portion 42F that protrudes toward a downward side from the front-side flange portion 42E.

A front end portion of the equipment base 42 is fixed to a cross member 12 by screwing a bolt, omitted from illustration, that is inserted from upward side into the front-side flange portion 42E and the boss portion 42F of the equipment base 42, into a nut, omitted from illustration, that is provided on the cross member 12.

The material of the equipment base 42 is not limited in particular, but is preferably made of aluminum, from the perspective of improving the heat dissipation performance of heat-generating equipment, such as relays, a junction box 34, and so forth, which will be described later. That is to say, the material of the equipment base 42 is preferably a material with high thermal conductivity, such as aluminum or an aluminum alloy.

The lid 44 is disposed on a lower side of a seat cushion 100, described below, in the vehicle up-down direction, and also above the storage battery case 28 in the vehicle up-down direction, at a position that overlaps the seat cushion 100 in top view. Specifically, the lid 44 is a sealing member that closes off an opening portion (open portion) at the top end of the equipment base 42, and is fixed to the equipment base 42. The lid 44 includes an upper wall portion 44A, a rear wall portion 44B, and a rear-side flange portion 44C. The lid 44 also includes an upper-side protrusion 44D at the middle of the upper wall portion 44A in the front-rear direction.

The lid 44 has thermal conductivity, and is preferably made of a material with high thermal conductivity, an example of which is aluminum. That is to say, the material of the lid 44 is a material with high thermal conductivity, such as aluminum, an aluminum alloy, or the like. The lid 44 is attached to the equipment base 42 from the upward side, such that the equipment disposal space 32 is formed between the lid 44 and the equipment base 42. The junction box 34 (control device), an electronic control unit (ECU) (control device) 35, and so forth, are disposed in this equipment disposal space 32.

Although omitted from illustration, relays, auxiliary devices, and so forth, are provided inside the junction box 34. The auxiliary devices include, for example, a power distribution unit (PDU), an ECU, and so forth. The relays and the auxiliary devices are linked to the storage battery pack 18 by a wiring conduit 88 (see FIG. 3 ), such as a wire harness or the like, which will be described later, and are electrically connected to the storage battery pack 18. Heat-generating equipment such as relays or the like are driven by power supplied from the storage battery pack 18, and may generate heat due to driving thereof.

An accessory cover 90 includes an upper wall portion 90A that is disposed facing the upper wall portion 44A of the lid 44 in the up-down direction, and a front wall portion 90B that extends downward from a front end of the upper wall portion 90A. Due to the accessory cover 90 being attached to the lid 44 from the upward side thereof, an equipment disposal space 36 is formed between the accessory cover 90 and the lid 44. Charging equipment 38, such as, for example, a 2-in-1 charger or the like, is disposed on a forward side of the upper-side protrusion 44D in this equipment disposal space 36.

On the other hand, as illustrated in FIG. 2, a connector block 50 is connected to the flange portion 25 of the lower case 24. In other words, the connector block 50 is disposed on a lower side of the upper case 26. A front side of the connector block 50 is linear in the vehicle width direction. In contrast, a rear side of the connector block 50 is curved such that the center in the vehicle width direction is convex toward rearward of the vehicle.

Also, as illustrated in FIG. 2, the connector block 50 includes a recessed portion 51 that is open on a lower side thereof in the vehicle up-down direction as viewed from the vehicle width direction, and a protruding portion 52 in which the recessed portion 51 is formed. The connector block 50 also includes a peripheral edge portion 53 extending outward from a lower end of the protruding portion 52, and a rear-end portion 54 extending from the peripheral edge portion 53 toward the rear end side.

Also, an opening portion 25A is provided in the flange portion 25 of the lower case 24, passing through in the vehicle up-down direction, and the protruding portion 52 of the connector block 50 is fit into this opening portion 25A. That is to say, a lower face of the flange portion 25 of the lower case 24 abuts against an upper face of the peripheral edge portion 53 of the connector block 50. In other words, the upper face of the peripheral edge portion 53 of the connector block 50 abuts against a lower face of a peripheral edge portion of the opening portion 25A.

Specifically, the lower face of the flange portion 25 of the lower case 24 abuts against a forward upper face of the peripheral edge portion 53 of the connector block 50. The flange portion 25 of the lower case 24 and a rear-end portion 26A of the upper case 26 overlap and abut against an upper face of the rear-end portion 54 of the connector block 50. That is to say, the lower face of the flange portion 25 of the lower case 24, of which the upper face is joined to the rear-end portion 26A of the upper case 26, abuts against a rear upper face of the peripheral edge portion 53 of the connector block 50. In other words, the rear-end portion 26A of the upper case 26 indirectly abuts the upper face of the peripheral edge portion 53 of the connector block 50 via the flange portion 25 of the lower case 24.

In the present embodiment, the connector block 50 is made of a thermally conductive member, a specific example of which is aluminum. The material of the connector block 50 is preferably a material with high thermal conductivity, such as aluminum or an aluminum alloy. Also, is more preferable to use a die-cast member (cast article) formed by casting aluminum or the like. Note that the connector block 50 does not necessarily have to be a cast article, and may be made of a metal (e.g., aluminum or stainless steel) plate, resin, or the like.

FIG. 3 is an enlarged perspective view of principal portions of the vehicle rear structure 14 according to the present embodiment, illustrated in an enlarged manner, illustrating a perspective view of the rear plate 24R side of the lower case 24.

As illustrated in FIG. 1, a smoke discharge valve 82 is attached to the connector block 50. As illustrated in FIG. 3, a cover plate 84 is attached to the connector block 50, between the storage battery pack 18 and the smoke discharge valve 82. The cover plate 84 is provided with an opening portion 84A on the side face that faces the storage battery cell 22 side, through which exhaust smoke from inside the storage battery cell 22 flows in. Note that when smoke flows into a smoke exhaust flow path (omitted from illustration) provided in the storage battery pack 18, and the internal pressure thereof rises above a predetermined value, the smoke discharge valve 82 opens and externally discharges the gas inside the smoke exhaust channel.

Additionally, breather membranes 85 are attached to the connector block 50. The breather membranes 85 are designed to allow gasses to pass through but to keep liquids (including steam) from passing through.

Also, as illustrated in FIGS. 1 to 3, a plurality of connectors 60, which is connected to the storage battery pack 18 and is used to supply power to various parts of the vehicle, is disposed on a lower face side of the connector block 50. In the present embodiment, the connectors 60 include a first connector 60A, a second connector 60B, a third connector 60C, and a fourth connector 60D, as an example. Note that in the following description, the first connector 60A, the second connector 60B, the third connector 60C, and the fourth connector 60D will be referred to simply as connectors 60, when not being distinguished from each other in particular, and common features are being described.

The connectors 60 are attached to terminal ends of cables (omitted from illustration). As illustrated in FIGS. 1 and 3, the connectors 60 are disposed along the vehicle width direction. Each of the connectors 60 is disposed such that the entirety thereof overlaps part of the storage battery case 28 in bottom view. As illustrated in FIG. 2, the connector 60 is disposed so as not to protrude below the lower face of the lower plate 24L of the storage battery case 28. Also, as illustrated in FIG. 1, the connectors 60 are disposed such that the first connector 60A is disposed on the smoke discharge valve 82 side, and the second connector 60B, the third connector 60C, and the fourth connector 60D are each disposed on the opposite side of the first connector 60A from the smoke discharge valve 82.

The first connector 60A is connected to equipment disposed at the front of the vehicle, via a cable or the like. This equipment is, for example, a vehicle drive motor installed in the front of the vehicle 10.

The fourth connector 60D is connected to equipment disposed at the rear of the vehicle, via a cable or the like. This equipment is, for example, a vehicle drive motor installed in the rear of a vehicle. This equipment is disposed a position that is, for example, behind a rear end of the storage battery pack 18 and at the middle of the vehicle width direction. In the present embodiment, this equipment is the junction box 34 (control device), the ECU (control device) 35, and so forth, which are arranged in the equipment disposal space 32, as illustrated in FIG. 2.

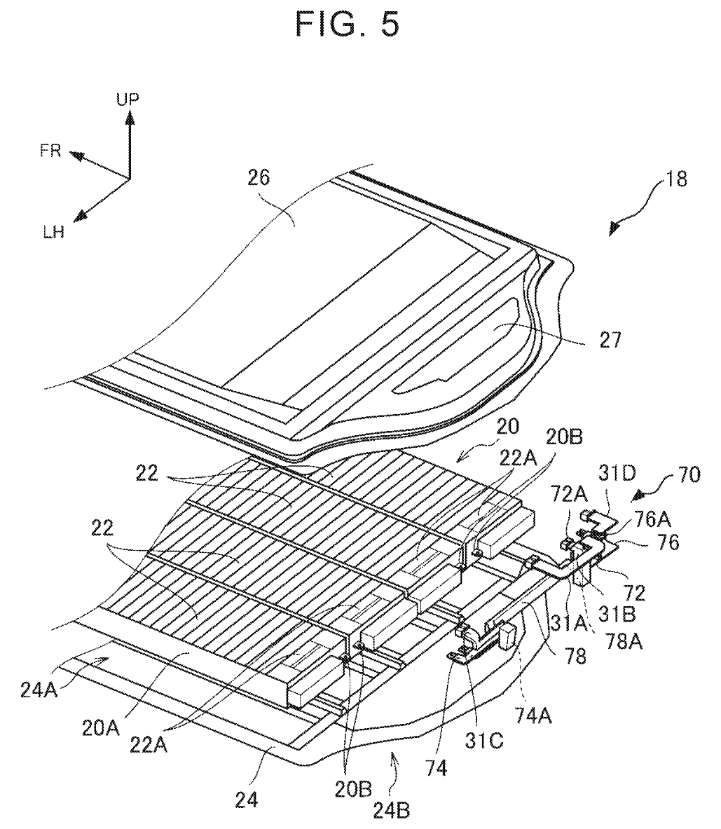

As an example, as illustrated in FIG. 2, the fourth connector 60D is attached to the lower side of the flange portion 25 of the lower case 24. An upper face portion 61 of the fourth connector 60D is supported on a lower face of the protruding portion 52 of the connector block 50 via a connector terminal block (omitted from illustration). Note that the connector terminal block is electrically connected to the junction box 34 and so forth, disposed in the equipment disposal space 32, via a bus bar 70 (see FIGS. 4 and 5).

On the other hand, the connector block 50 is provided with the smoke discharge valve 82 and the breather membranes 85 on the outer side in the vehicle width direction, and as illustrated in FIG. 1, a routing block 80 is formed on the vehicle rearward side from the smoke discharge valve 82 and the breathing membranes 85. A first insertion hole 80A and a second insertion hole 80B, which are circular, are formed inside the routing block 80, passing through the connector block 50 in the up-down direction. In present embodiment, there are two first insertion holes 80A, and there is one second insertion hole 80B that has a larger diameter than the first insertion holes 80A. Also, the second insertion hole 80B is provided on the outer side in the vehicle width direction, from the first insertion holes 80A. The two first insertion holes 80A are spaced apart in the vehicle width direction, and further, the second insertion hole 80B is also spaced apart in the vehicle width direction from the first insertion holes 80A.

Circulation pipes 86 for circulating coolant to installed equipment of the vehicle, for example, are inserted into the first insertion holes 80A. Also, the wiring conduit 88, accommodating a plurality of wires for transmitting electrical signals to the installed equipment, is inserted into the second insertion hole 80B. The circulation pipes 86 and the wiring conduit 88 are examples of routing members that are routed in a vehicle. That is to say, in the present embodiment, a structure is employed in which a plurality of routing members, spaced apart from one another in the vehicle width direction, are inserted into the routing block 80 in the up-down direction.

FIG. 4 is a schematic sectional view taken along line A-A in FIG. 1. As illustrated in FIG. 4, the breather membranes 85 are communicable with a gap 29 provided between an upper plate 26U of the upper case 26 and the flange portion 25 of the lower case 24. Note that this gap 29 communicates with an accommodation portion 23 in which each of the storage battery modules 20 is accommodated.

As illustrated in FIG. 4, in the present embodiment, the bus bar 70 is electrically connected to the storage battery module 20 and is arranged between the upper case 26 and the connector block 50 in the vehicle up-down direction. Specifically, the bus bar 70 is disposed on the vehicle rearward side of the storage battery case 28, and is disposed on the upper side from the cover plate 84 (see FIG. 3). In the present embodiment, the cover plate 84 is spaced apart from the bus bar 70.

Now, the bus bar 70 will be described. FIG. 5 is an exploded perspective view illustrating principal portions of a rear part of the storage battery pack 18 illustrated in FIG. 1, in an enlarged manner. As illustrated in FIG. 5, the bus bar 70 includes a positive bus bar 72 and a negative bus bar 74, which are electrically connected to the storage battery modules 20. The storage battery module 20 is made up of the storage battery cells 22 aligned in a row along the front-rear direction, end plates 22A arranged at both end portions thereof in the front-rear direction and supporting the storage battery cells 22, and a support body 20A supporting the storage battery cells 22 and the end plates 22A. Each of the end plates 22A is provided with one each of terminals 20B that make up the positive terminal and the negative terminal of the storage battery module 20.

The lower case 24 is sectioned into a module installation region 24A in which the storage battery modules 20 are placed, and a bus bar arrangement region 24B in which the positive bus bar 72 and the negative bus bar 74 are arranged. The module installation region 24A is configured as a rectangular region that matches the shape of the storage battery modules 20. Also, the bus bar arrangement region 24B is configured as a region that narrows rearward so as to ensure space for routing the positive bus bar 72 and the negative bus bar 74, while not interfering with rear wheels of the vehicle in which the storage battery pack 18 is installed.

The polarities of the terminals 20B at both ends in the front-rear direction of each of the storage battery modules 20 installed in the module installation region 24A can be adjusted in accordance with the form of connection among the storage battery modules 20. In the present embodiment, the terminals 20B of the storage battery modules 20, which are adjacent, on each of the front side and the rear side are disposed so as to have different polarities, as an example.

Also, the equipment case 40 (see FIG. 4) is disposed at a rearward upper portion of the upper case 26, such that at least a portion thereof overlaps with the positive bus bar 72 and the negative bus bar 74 in plan view. The opening portion 27 is provided in a portion of the upper case 26 corresponding to the bus bar arrangement region 24B, and passes through in the up-down direction and electrically connects the equipment case 40 and the storage battery module 20. Note that in FIG. 5, the equipment case 40 is omitted from illustration.

The positive bus bar 72 is connected to the positive terminals of the storage battery modules 20 and is also led out to the bus bar arrangement region 24B. The positive bus bar 72 makes up part of wires for connecting the storage battery modules 20 to electrical equipment inside the equipment case 40, and can be formed from a strip-shaped metal plate. In the present embodiment, the positive bus bar 72 is provided with contacts (omitted from illustration) at both ends thereof, and one of the contacts is electrically connected to the terminal 20B provided on the rearward end plate 22A at one end side in the right-left direction out of the storage battery modules 20 that are electrically connected to each other. Also, the positive bus bar 72 is covered with an insulating cover (omitted from illustration) except for the contacts thereof. Various types of bus bars, including the positive bus bar 72 used in the present embodiment, can be made of copper, aluminum, brass, or alloys thereof.

The negative bus bar 74 is connected to the negative terminals of the storage battery modules 20 and is also led out to the bus bar arrangement region 24B. Like the positive bus bar 72, this negative bus bar 74 also makes up part of the wires for connecting the storage battery modules 20 to the electrical equipment inside the equipment case 40, and can be made of a strip-shaped metal plate. In the present embodiment, the negative bus bar 74 is provided with contacts (omitted from illustration) at both ends thereof, and one of the contacts is electrically connected to the terminal 20B provided on the rearward end plate 22A at the other end in the right-left direction out of the storage battery modules 20 that are electrically connected to each other. Also, the negative bus bar 74 is covered with an insulating cover (omitted from illustration) except for the contacts thereof.

By disposing the positive bus bar 72 and the negative bus bar 74 rearward from the storage battery modules 20, wiring space for each of the bus bars can be concentrated behind the storage battery modules 20. Employing such a configuration does away with the need to reserve space in the module installation region 24A of the lower case 24 to arrange the positive bus bar 72 and the negative bus bar 74, and accordingly the space for installing the storage battery module 20 can be made to be compact. In addition, the positive bus bar 72 and the negative bus bar 74 are disposed in a concentrated manner, and accordingly assembly work, including connection work between the positive bus bar 72 and the negative bus bar 74, and the electrical equipment and so forth inside the equipment case 40, is facilitated. Note that the positive bus bar 72 and the negative bus bar 74 are fixed to the lower case 24, the upper case 26, and so forth, by fixing means such as bolts or the like that are omitted from illustration.

Also, in the storage battery pack 18, a pair of neutral point bus bars 76, 78 is connected to neutral points of the storage battery modules 20 that are electrically connected to each other, to enable partial charging and discharging of the storage battery modules 20. In the present embodiment, the neutral point bus bars 76, 78, like the positive bus bar 72 and the negative bus bar 74, are led out rearward from the storage battery modules 20 and arranged in the bus bar arrangement region 24B. Note that a neutral point refers to a midpoint that divides the voltage of multiple storage battery modules, which are electrically connected, into two equal parts, or a voltage reference point. Also, the position of the neutral point does not need to strictly equally divide into two the voltages of the multiple storage modules, and may be a point at which the voltage is intermediate between the voltage of the positive bus bar 72 and the voltage of the negative bus bar 74.

The neutral point bus bars 76, 78, like the positive bus bar 72 and the negative bus bar 74, make up wiring for connecting the storage battery modules 20 to the electrical equipment inside the equipment case 40, and can be formed, for example, from a strip-shaped metal plate. The neutral point bus bars 76, 78 are each provided with contacts (omitted from illustration) at both ends thereof. One contact of these neutral point bus bars 76, 78 is connected to the neutral point of the storage battery modules 20 that are electrically connected. As an example, one contact of one of the neutral point bus bar 76 is electrically connected to the terminal 20B provided on the end plate 22A rearward of the storage battery modules 20. Also, one contact of the other neutral point bus bar 78 is electrically connected to the terminal 20B provided on the end plate 22A rearward of the storage battery modules 20. Also, portions of the neutral point bus bars 76, 78 other than the contact points thereof are each covered with insulating covers (omitted from illustration). The polarity of the terminals 20B to which the neutral point bus bars 76, 78 are connected is not limited in particular, but the polarity of each of the terminals 20B is adjusted such that, for example, one neutral point bus bar 76 is negative and the other neutral point bus bar 78 is positive.

The other contact (omitted from illustration) of each of the bus bars described above is connected to the electrical equipment inside the equipment case 40, but attempting to directly route each of the bus bars to the electrical equipment inside the equipment case 40, the overall length of each of the bus bars may become long, which may make handling and managing difficult. Accordingly, in the present embodiment, the other contact (omitted from illustration) of the positive bus bar 72 is connected to a terminal block 72A, and similarly, the other contact (omitted from illustration) of the negative bus bar 74 is connected to a terminal block 74A, the other contact (omitted from illustration) of the one neutral point bus bar 76 is connected to a terminal block 76A, and the other contact (omitted from illustration) of the other neutral point bus bar 78 is connected to a terminal block 78A, respectively. A configuration is employed in which the positive bus bar 72, the negative bus bar 74 and the neutral point bus bars 76, 78 connect to the electrical equipment inside the equipment case 40 via these terminal blocks 72A, 74A, 76A, 78A. Note that in FIG. 5, among these terminal blocks 72A, 74A, 76A, 78A, the terminal block 74A to which the other contact (omitted from illustration) of the negative bus bar 74 is connected, and the terminal block 78A to which the other contact (omitted from illustration) of the other neutral point bus bar 78 is connected, are arranged in positions hidden by other members.

The storage battery pack 18 includes an equipment-side positive bus bar 31A, an equipment-side negative bus bar 31B, and two equipment-side neutral point bus bars 31C, 31D, each of which has one end connected to the terminal blocks 72A, 74A, 76A, 78A that are described above. The equipment-side positive bus bar 31A, the equipment-side negative bus bar 31B, and the two equipment-side neutral point bus bars 31C, 31D can be formed from strip-shaped metal plates arranged rearward from the electrical equipment inside the equipment case 40. Also, the other ends of the equipment-side positive bus bar 31A, the equipment-side negative bus bar 31B, and the two equipment-side neutral point bus bars 31C, 31D are electrically connected to the electrical equipment inside the equipment case 40, more specifically, to the junction box 34 (see FIG. 5).

The equipment-side positive bus bar 31A is electrically connected to the positive bus bar 72 via the terminal block 72A, the equipment-side negative bus bar 31B is electrically connected to the negative bus bar 74 via the terminal block 74A, and the two equipment-side neutral point bus bars 76, 78 are electrically connected to the two neutral point bus bars 76, 78 via the terminal blocks 76A, 78A, respectively. Also, the terminal blocks 72A, 74A, 76A, 78A are arranged, for example, at positions overlapping the opening portion 27 in plan view such that connections to the equipment-side positive bus bar 31A, the equipment-side negative bus bar 31B, and the two equipment side neutral point bus bars 31C, 31D can be realized over short distances, and also connection work thereof can be facilitated.

Using the above-described terminal blocks 72A, 74A, 76A, 78A, enables the overall length of each of the bus bars to be shortened, facilitating handling of the bus bars. In addition, the connections of the terminal blocks 72A, 74A, 76A, 78A, to the equipment-side positive bus bar 31A, the equipment-side negative bus bar 31B, and the two equipment-side neutral point bus bars 31C, 31D, respectively, can be performed at the same time as when the electrical equipment inside the equipment case 40 is attached to the top of the upper case 26 of the storage battery case 28, thereby facilitating assembly.

### Functions and Effects

Next, the functions and effects of the present embodiment will be described.

In the vehicle rear structure 14 according to the present embodiment, the bus bar 70 is arranged between the connector block 50 that has thermal conductivity and the upper case 26, in the vehicle up-down direction, such that heat generated in the bus bar 70 can be dissipated through the connector block 50.

Also, in the vehicle rear structure 14 according to the present embodiment, the upper case 26 is indirectly connected to the connector block 50 via the lower case 24, and accordingly heat dissipated from the bus bar 70 toward the upper case 26 can be dissipated via the connector block 50. This enables the heat generated in the bus bar 70 to be efficiently dissipated via the connector block 50.

Also, in the vehicle rear structure 14 according to the present embodiment, the connector block 50 has the peripheral edge portion 53 thereof abutted against the lower case 24, and is indirectly abutted against the upper case 26 via the lower case 24, such that heat dissipated from the bus bar 70 toward the upper case 26 can be dissipated via the connector block 50. This enables the heat generated in the bus bar 70 to be dissipated even more efficiently via the connector block 50.

Also, in the vehicle rear structure 14 according to the present embodiment, the connector block 50 is made of aluminum, and accordingly heat dissipated from the bus bar 70 toward the upper case 26 can be efficiently dissipated via the connector block 50.

Although an embodiment of the disclosure has been described above, it goes without saying that the disclosure is not limited to the above description, and that various modifications other than the above can be carried out without departing from the spirit thereof.

What is claimed is:

1. A vehicle rear structure comprising:
a battery case that includes an upper case and a lower case, and that accommodates one or more battery modules within;
a connector block that is thermally conductive, and that is disposed on a downward side from the upper case in a vehicle up-down direction; and
a bus bar that is electrically connected to the battery module, and that is arranged between the upper case and the connector block in the vehicle up-down direction.

2. The vehicle rear structure according to claim 1, wherein the upper case indirectly abuts against the connector block via the lower case.

3. The vehicle rear structure according to claim 2, wherein the connector block includes a peripheral edge portion that abuts against the lower case, and indirectly abuts against the upper case via the lower case.

4. The vehicle rear structure according to claim 1, wherein the connector block is made of aluminum.
